(19) United States
(12) Patent Application Publication
(10) Pub. No.: US 2016/0037851 A1
(43) Pub. Date: Feb. 11, 2016

(54) MATERIAL FOR MITIGATING IMPACT FORCES WITH COLLISION DURATIONS IN NANOSECONDS TO MILLISECONDS RANGE

(71) Applicant: THE REGENTS OF THE UNIVERSITY OF CALIFORNIA, Oakland, CA (US)

(72) Inventors: Vijay Gupta, Sherman Oaks, CA (US); Jason K. Citron, Los Angeles, CA (US); George H. Youssef, La Mesa, CA (US)

(21) Appl. No.: 14/827,120

(22) Filed: Aug. 14, 2015

Related U.S. Application Data
(63) Continuation of application No. 13/879,616, filed on Aug. 7, 2013.
(60) Provisional application No. 61/393,735, filed on Oct. 15, 2010.

(51) Int. Cl. A42B 3/12; B29B 7/00; B29C 39/00; B29C 39/42; A41D 31/00; C08J 9/00

(52) U.S. Cl. CPC A42B 3/125; A41D 31/0044; C08J 9/00; B29C 39/003; B29C 39/42; B29B 7/00; C08J 2375/02; B29K 2075/00

(57) ABSTRACT

Material for mitigating impact forces with collision durations in nanoseconds to milliseconds range is disclosed. According to one embodiment, an object wearable on or against a human body comprises one of a layer of polyurea material and plug of polyurea material, and the layer of polyurea material or plug of polyurea material is positioned within the object or on the object between the human body and an outer structure of the object.

The present application is a continuation of U.S. patent application Ser. No. 13/879,616, filed on Apr. 15, 2013, which claims the benefit of and priority to U.S. Provisional Application No. 61/393,735 titled “Material For Mitigating Impact Forces With Collision Durations In Nanoseconds To Milliseconds Range,” filed on Oct. 15, 2010, which is hereby incorporated by reference in its entirety.

### FIELD

The present disclosure relates generally to the mitigation of impact forces and, more particularly, to a material and process for producing a material for mitigating impact forces with collision durations in nanoseconds to milliseconds range.

### BACKGROUND

A dynamic impact is characterized by the force-time curve during the collision. Finding strategies (material or structural) to manage an impact depends upon the collision duration or the force amplitude of the force-time curve. High velocity impacts, such as those arising during combat missions, have durations in the nanoseconds to microseconds range (armor protection). Collisions with durations in the 1 ms to 100 ms range are common to virtually all day-to-day recreational and sports activities. Examples include, walking, running, jumping, aerobics, collisions between football helmets, a fast baseball striking a helmet, collisions during skiing, boxing, all racquet sports, debris/bird hitting an aircraft, etc.

Most impact resistance or absorbing materials are effective in managing impact in a very specific collision duration range. There has been no indication that such materials are effective in managing impacts having durations ranging from 1 to 100 milliseconds, which is the duration range for impacts occurring during sports and recreational activities. Most importantly, conventional materials are unlikely to be effective in reducing impact forces when the material strains are minimal as basic scientific principles require such materials to stretch significantly to absorb and dissipate impact energy. Because the force applied during sport and recreational related activities occurs over such a short time, the materials used in such activities experience a very small amount of stretching or deformation (i.e., less than 1% strain) due to the impact force. In general, the dynamic energy absorbing properties of most impact absorbing materials are only effective when the material is stretched 50 to 100 times more than what would actually occur as a result of impact forces applied during sport and recreation related activities and when the duration of the impact force is 100 to 1000 times longer than the duration of impact forces applied during sport and recreation related activities.

### SUMMARY

Material for mitigating impact forces with collision durations in nanoseconds to milliseconds range is disclosed. According to one embodiment, an object wearable on or against a human body comprises one of a layer of polyurea material and plug of polyurea material, and the layer of polyurea material or plug of polyurea material is positioned within the object or on the object between the human body and an outer structure of the object.

The systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

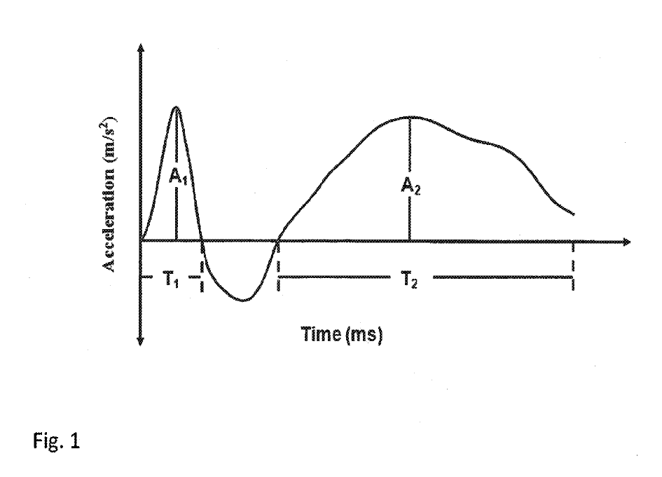

FIG. 1 illustrates an exemplary shockwave profile.

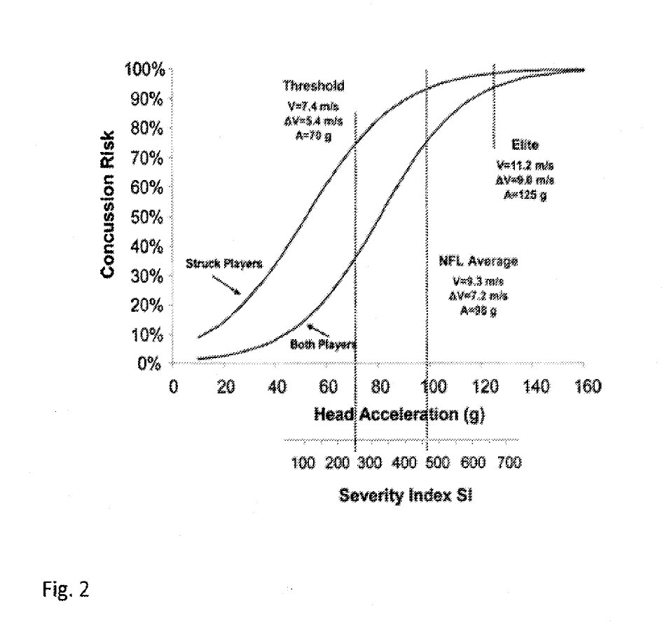

FIG. 2 illustrates the probability of concussion risk as a function of the relative linear acceleration of two colliding helmets.

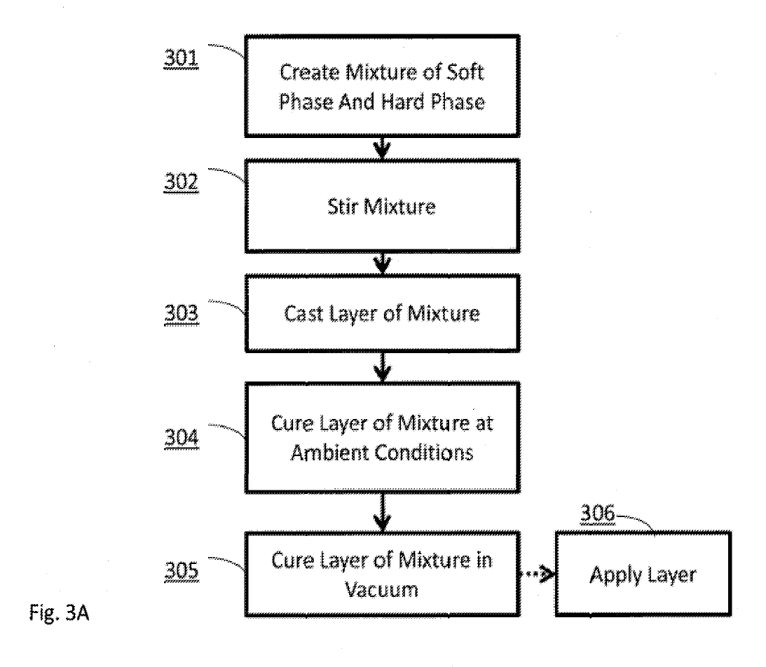

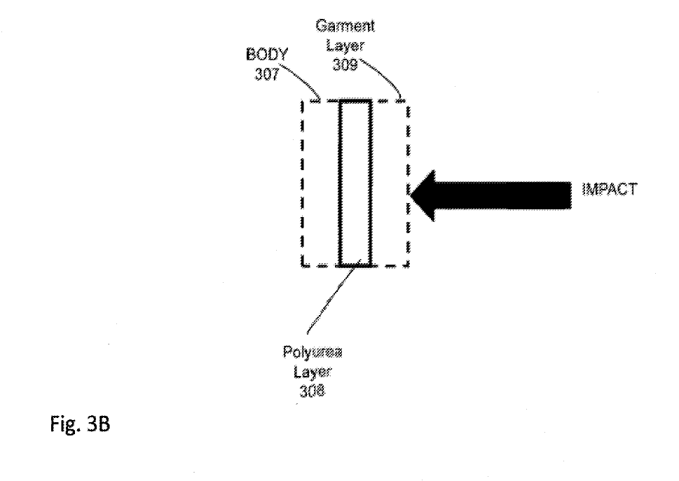

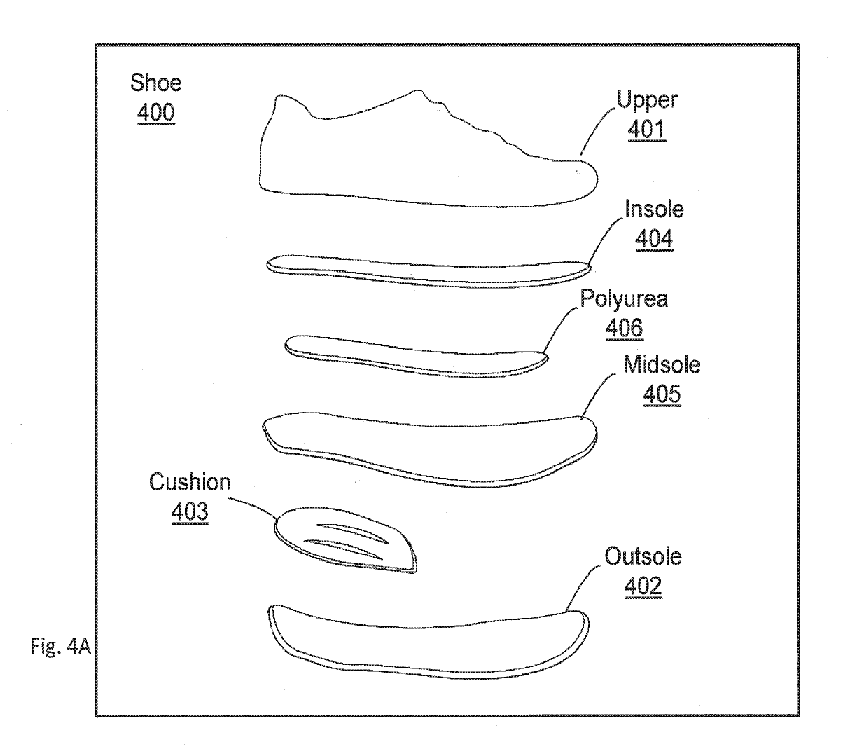

FIG. 3A illustrates an exemplary polyurea material preparation process for use with the present system, according to one embodiment.

FIG. 3B illustrates an exemplary garment including a wearable layer of the present polyurea material, according to one embodiment.

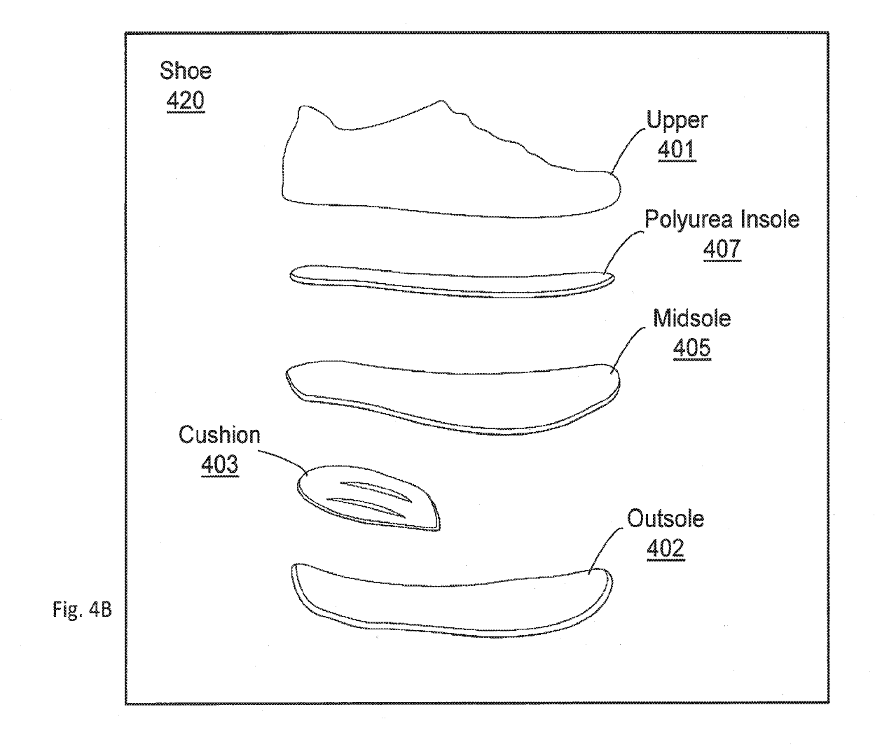

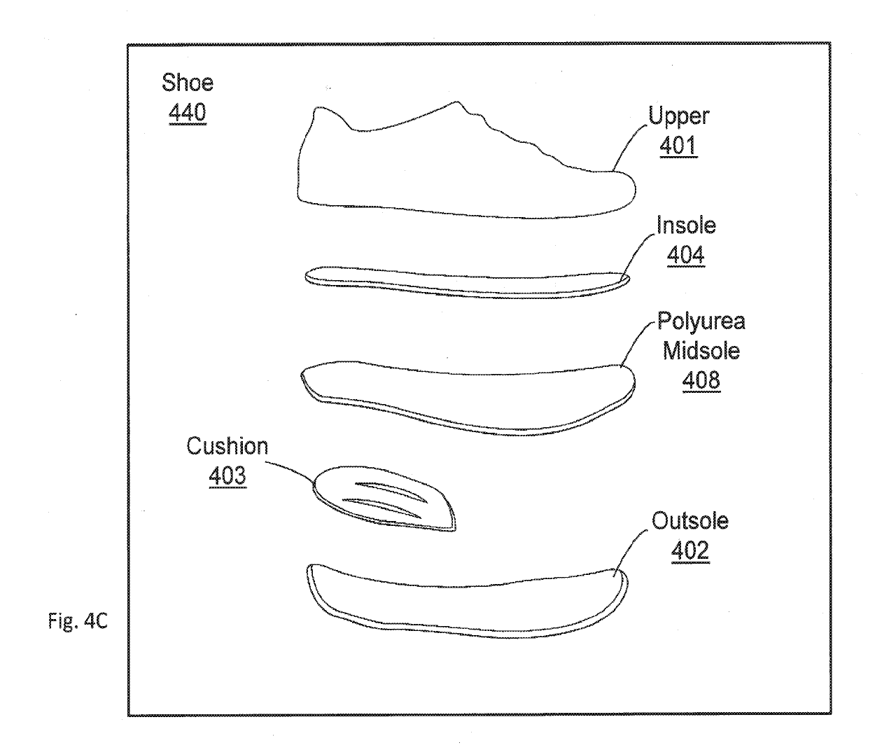

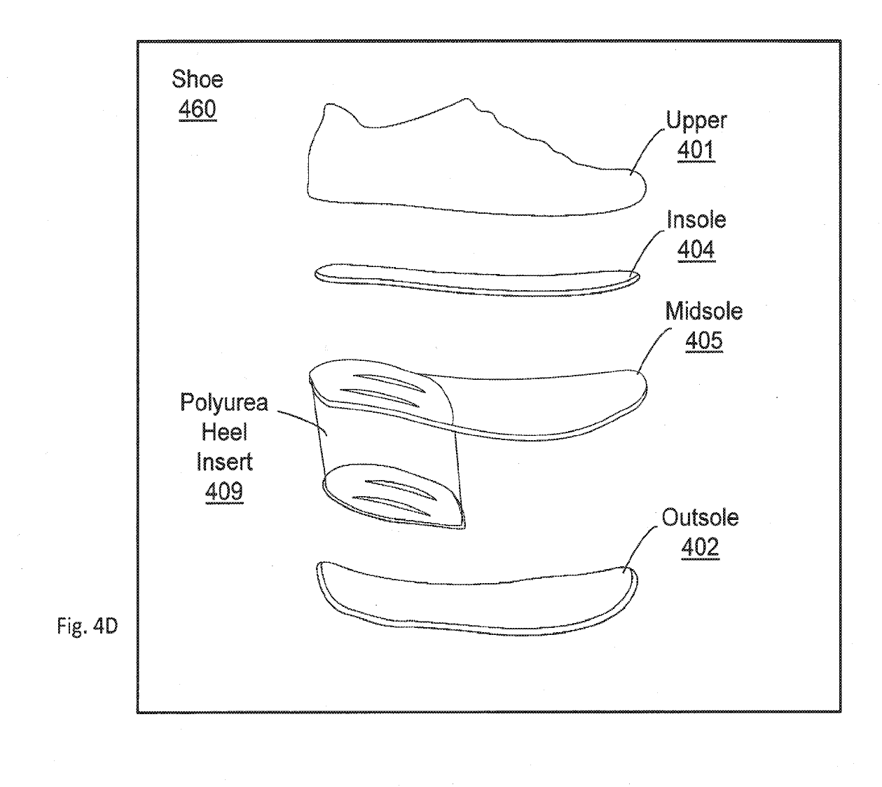

FIGS. 4A-4D illustrate exemplary improved shoe designs including the present polyurea material, according to one embodiment.

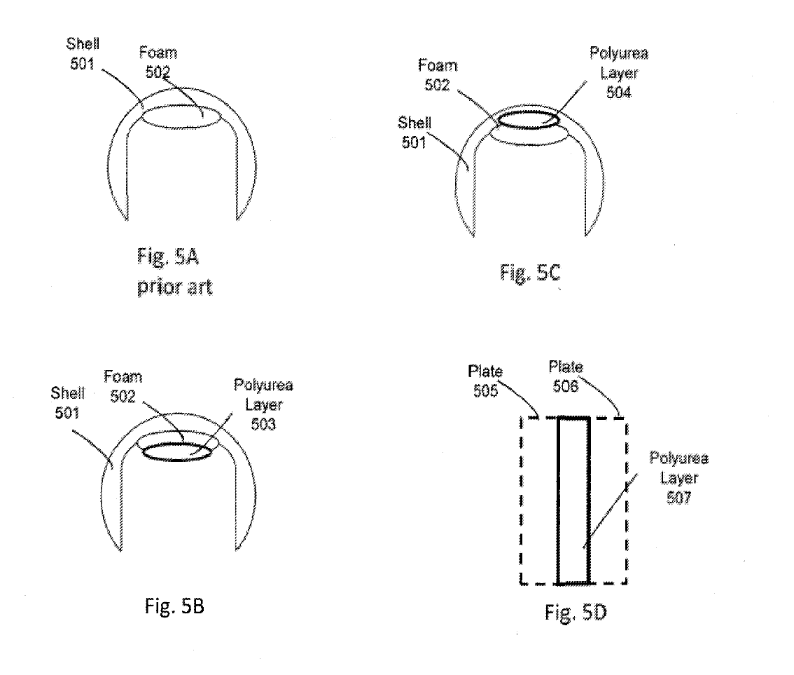

FIG. 5A illustrates a prior art helmet design.

FIG. 5B illustrates an exemplary helmet design including the present polyurea material, according to one embodiment.

FIG. 5C illustrates an exemplary helmet design including the present polyurea material, according to one embodiment.

FIG. 5D illustrates an exemplary combat helmet cross section including the present polyurea material, according to one embodiment.

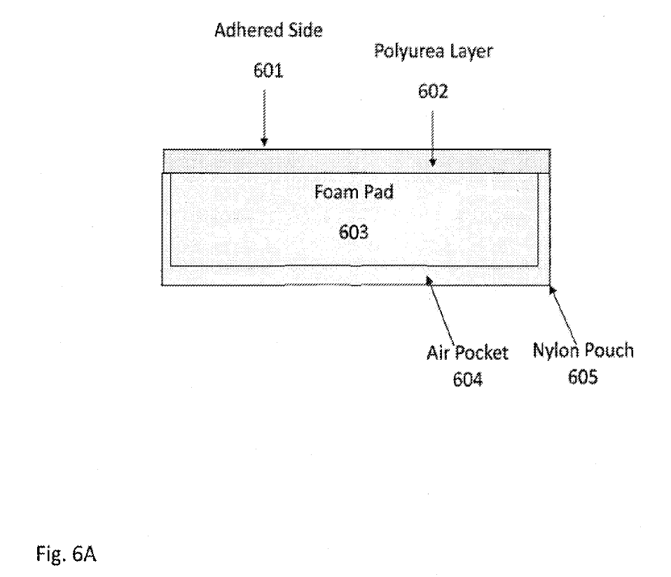

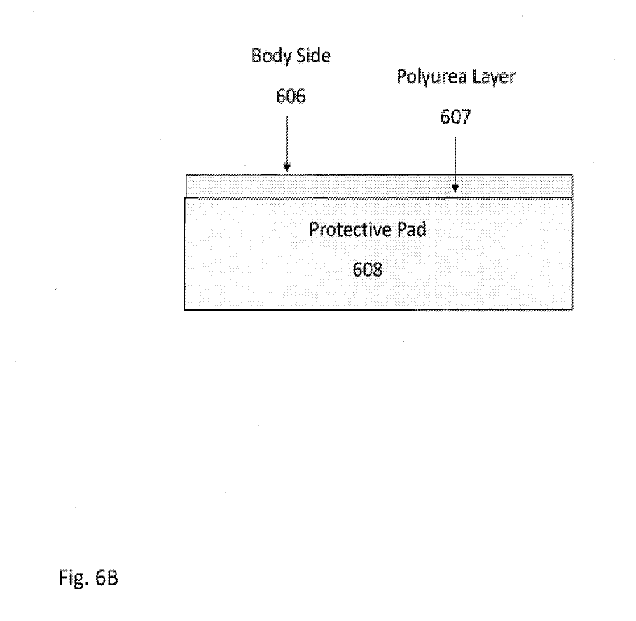

FIG. 6A illustrates an exemplary improved hip pad including the present polyurea material, according to one embodiment.

FIG. 6B illustrates an exemplary improved protective pad including the present polyurea material, according to one embodiment.

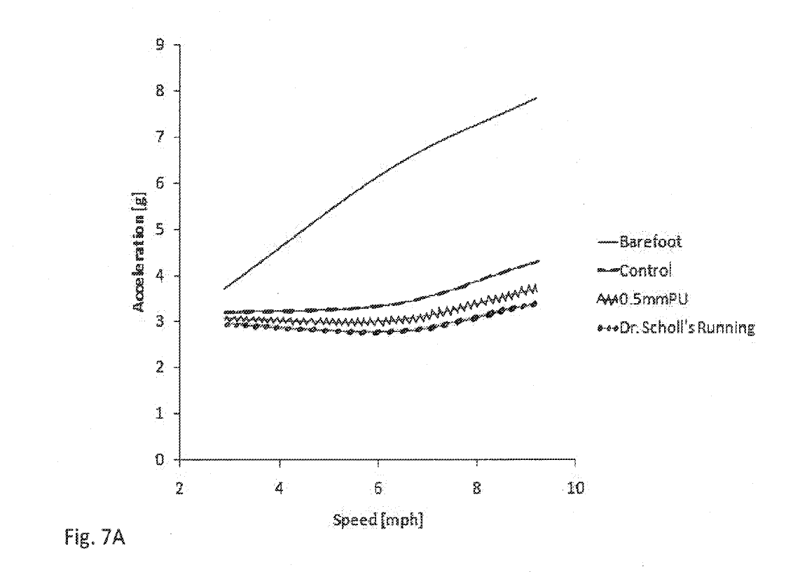

FIG. 7A illustrates tibial acceleration at different speeds.

FIG. 7B illustrates impact force reduction resulting from adding the present polyurea material to a shoe, according to one embodiment.

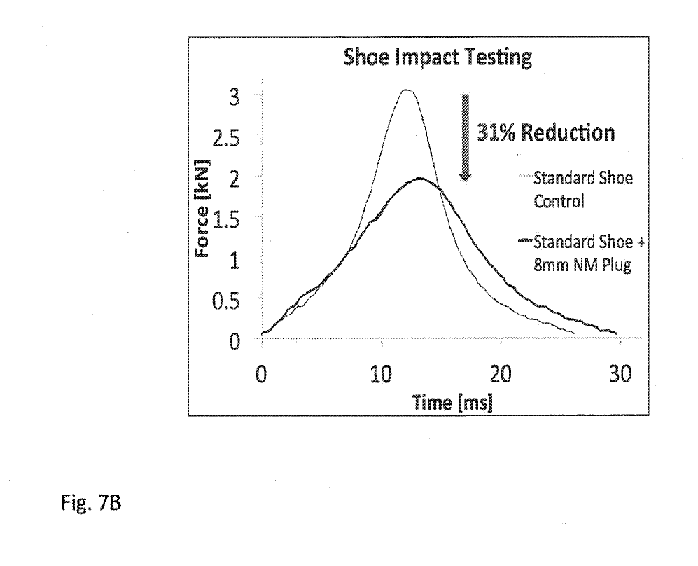

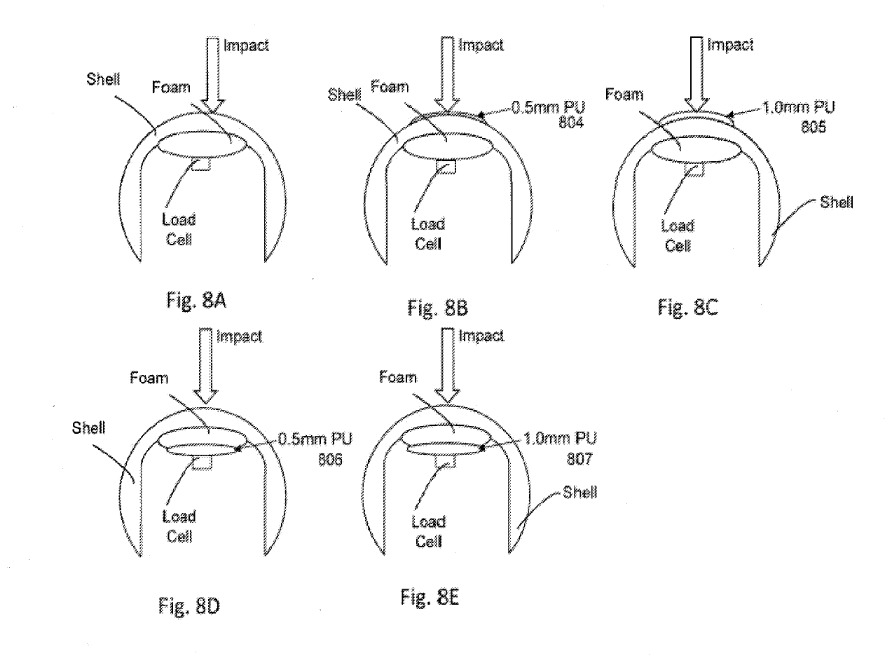

FIGS. 8A-8E illustrate exemplary test configurations for application of the present polyurea material to helmets.

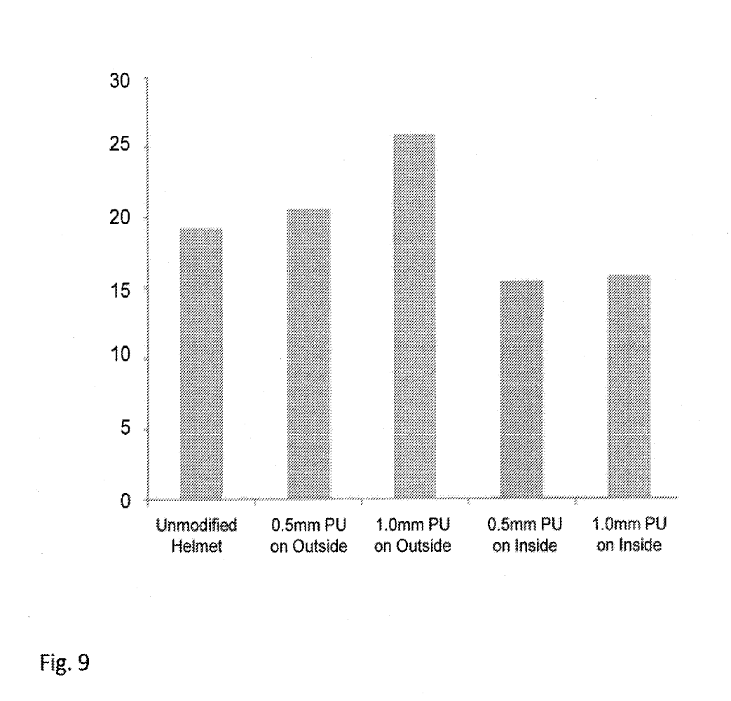

FIG. 9 illustrates the peak force for various polyurea thicknesses and locations in a helmet impacted with 74 Joules of impact energy, according to the configurations in FIGS. 8A-8E.

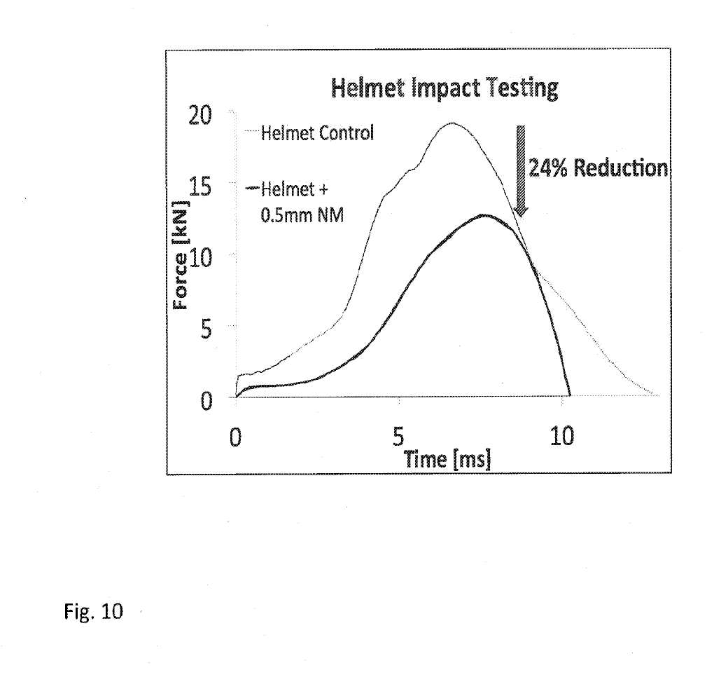

FIG. 10 displays the impact force reductions resulting from adding the present polyurea material to a helmet, according to one embodiment.

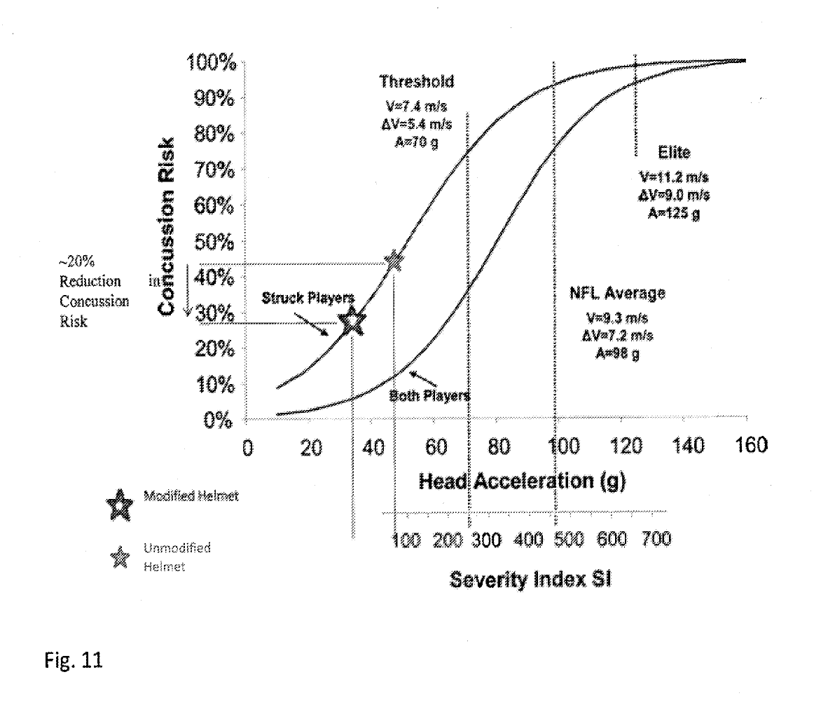

FIG. 11 illustrates a revised concussion probability curve as a result of the modified helmet according to FIG. 10.

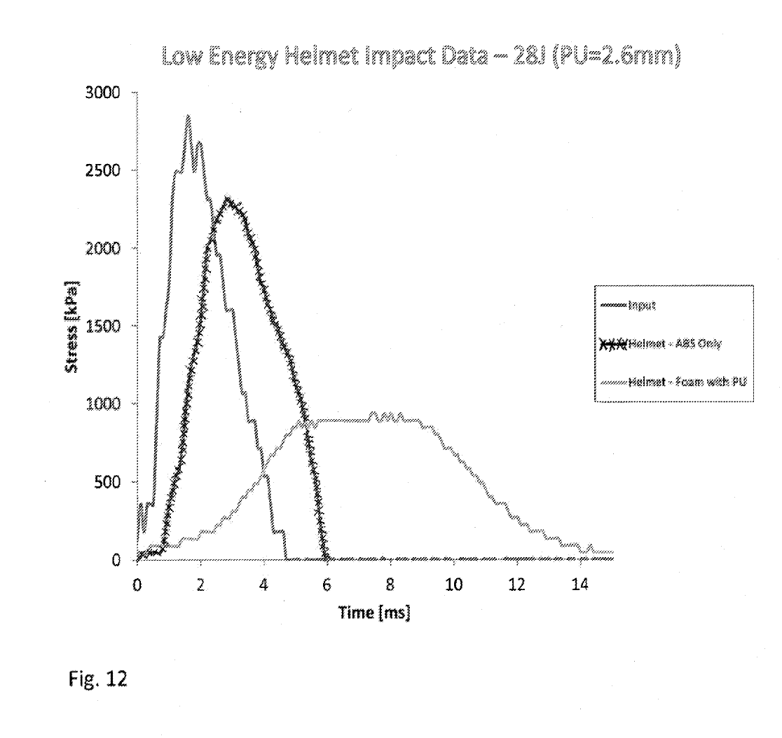

FIG. 12 illustrates impact data using a baseball helmet having the present polyurea material, according to one embodiment.

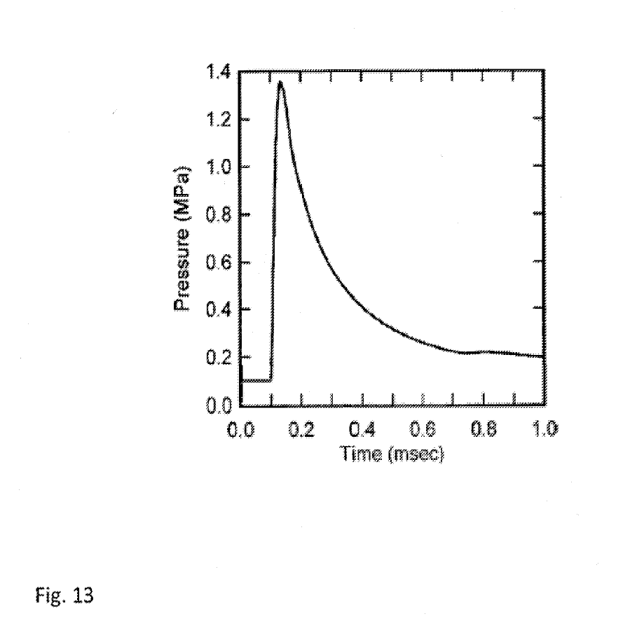

FIG. 13 illustrates a pressure-time curve from military blasts measured in the 1 to 10 milliseconds range.

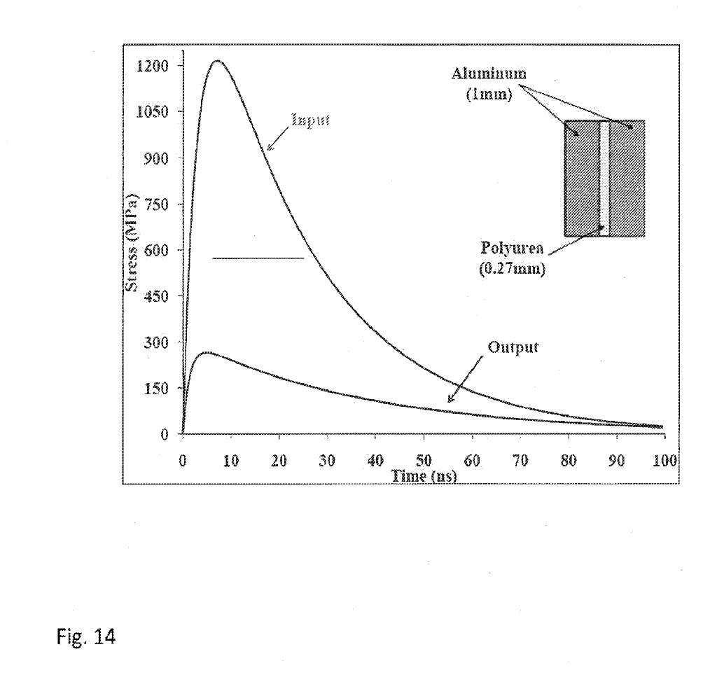

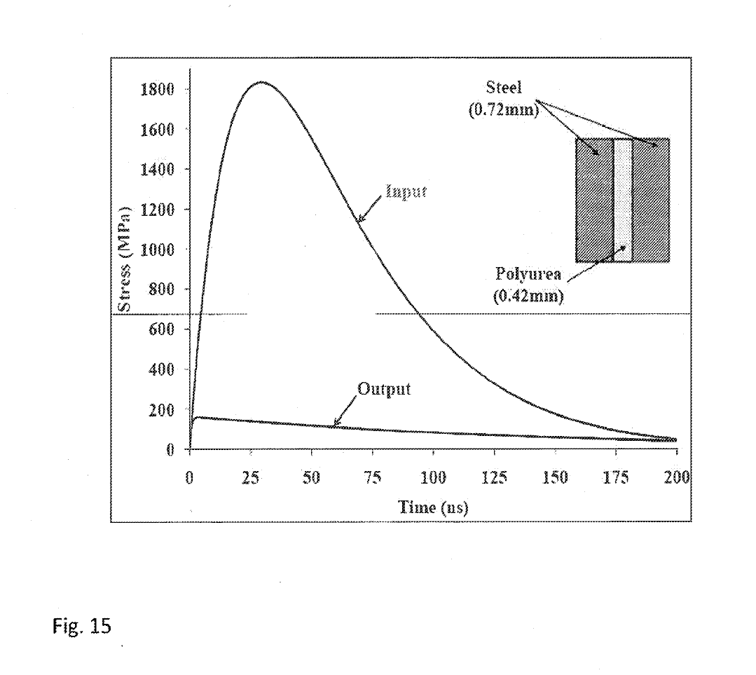

FIGS. 14 and 15 illustrate the impact results of layered armors having layers of the present polyurea material, according to one embodiment.

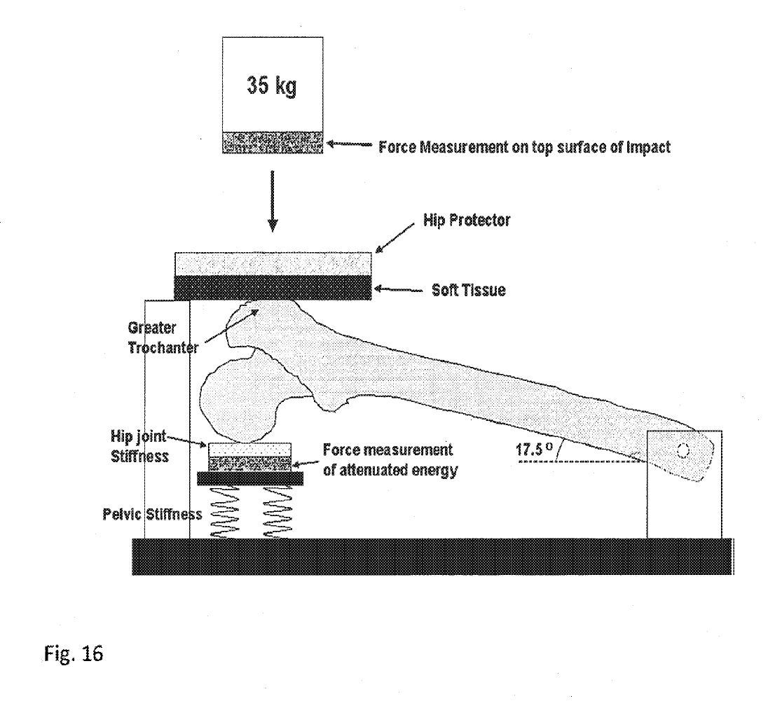

FIG. 16 illustrates an impact pad test configuration.

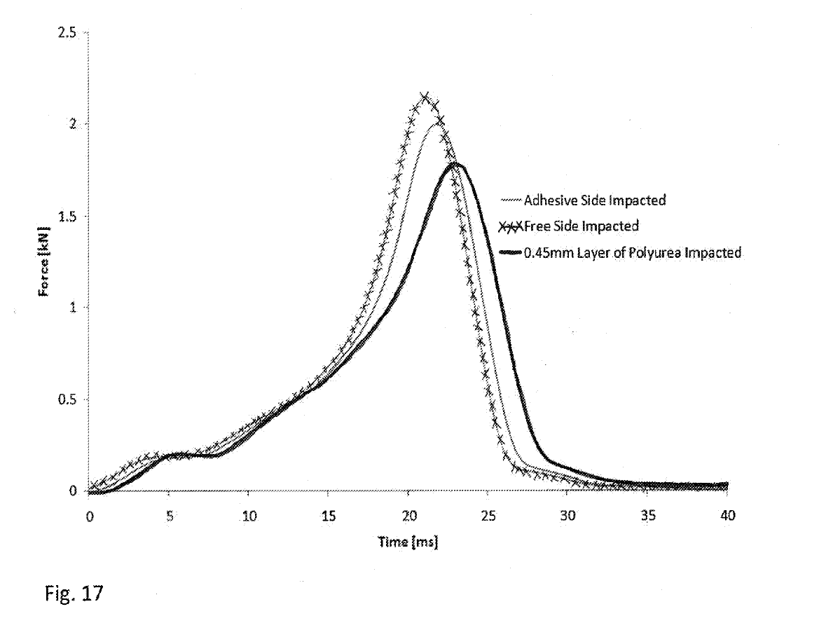

FIG. 17 illustrates the force-time curves for a hip impact pad with and without a layer of the present polyurea material.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

A material recipe and the process for producing a material including thin layers of polyurea are provided herein. Polyurea is a name given to a general class of viscoelastic elastomers prepared by mixing a soft (oligomeric diamine prepolymer), and a hard (modified diphenylmethane diisocyanate curative) phase. Both of these components are commercially available. For example the soft phase is marketed under the trade name Versalink® P1000 by Air Products Inc., while the hard phase is marketed under the trade name of Isonate 143L by Dow Chemical. A 1:1 ratio by weight results in an extremely hard polyurea while a ten to one ratio of the soft to hard phase by weight results in a gel-like material. Polyurea has been used widely as an adhesive and also as a water resistant and chemical resistant coating on truck beds and building facades because of its extreme chemical and water resistant properties.

The present polyurea material, made in accordance with the recipe and process described herein, mitigates impact forces with collision durations in the nanoseconds to milliseconds range. The polyurea material at the molecular level can be viewed as being composed of hard and soft phases. These phases deform synergistically to give the material its viscoelastic property. The material is able to engage the energy of impact pulses of widely varying durations (or frequencies) by deformation of its hard and soft phases in unison through resonance. The molecular structure is such that the material has a very high bulk modulus (which means it is very difficult to compress the sheet of this material in its thickness direction) and a very low shear modulus (meaning that it is easy to deform the material within its plane much like easy inter-card sliding in a deck of playing cards). Thus, the material can deflect the vertically-directed impact force and energy horizontally in its own plane. Because of this attribute, the material is ideal for applying to athletic surface or adding to shoes, socks and protective helmets to lower the impact force to an athlete or other user.

According to one embodiment, thin sheets of polyurea material are formed and then applied to a surface for protection. For example, thin sheets of a polyurea material prepared as described herein (the material referred to herein as “polyurea”) are glued to surfaces including: the inner protective foam or on the inner shell surface of protective helmets used in any sport (football, baseball, boarding, skiing, rafting, water sports, auto racing); inside shoes as inserts or insoles; in hip protector pads; in any protective pad including shin guards, chest and body guards for umpires or baseball catchers; and on the gym floors as mats for carrying out various aerobic exercises. The material can also be realized as bottom linings of socks, caps that can be worn over the skull before putting on helmets (bicycle, motorcycle, baseball, football, whitewater rafting, boarding, skiing, etc.), used by soldiers to cover their skulls and ears under their helmets to protect against traumatic brain injury, and used for body suits for entire body protection. Additionally the material can be used to protect against any impact-related forces arising in any sports or day-to-day activities. Surface application examples include playground surfaces in children's indoor and outdoor gyms, and machine floors of factories for vibration control.

The polyurea material described herein can be implemented in the existing manufacturing processes for various athletic helmets. Presently available helmets are inadequate for preventing concussion injuries, and an addition of the polyurea material described herein can help prevent these injuries. The same is the case with soldiers and marines in combat missions where the current helmet designs are inadequate for protecting them from shockwaves-induced traumatic brain injuries.

When molded into thin flexible layers (0.5 mm and higher), the polyurea material recipe described herein significantly reduces impact forces with collision times ranging from few nanoseconds to tens of milliseconds. High velocity impacts, such as those arising during combat missions, have durations in the nanoseconds to microseconds range (armor protection). As described above, collisions with durations in the 1 ms to 100 ms range are common to virtually all day-to-day recreational and sports activities. Again, examples include walking, running, jumping, aerobics, collisions between football helmets, a fast baseball striking a helmet, collisions during skiing, boxing, all racquet sports, vehicle impact, and debris/bird hitting an aircraft.

The present polyurea material performs in a very large range. Additionally, within each collision duration range, the use of a mere 0.5 mm to 1 mm thick layer on top of commercially available products and structures can cut down impact forces dramatically (over 15-20%).

The present system exhibits a rare combination of mechanical properties, a very high bulk modulus and a very low shear modulus. The high bulk modulus allows retention of high through-thickness stiffness such as against the foot pressure applied by a runner while the low shear modulus results in long relaxation times which in turn brings down the peak dynamic impact force.

The addition of a polyurea layer is effective in mitigating the effects of impact in situations governed by force-time curves on the order of 1 ns to 100 ms. Test data has shown that an optimized thin layer of polyurea preferably 0.5 mm to 1 mm in thickness can significantly reduce the negative effects associated with impacts on this time scale. Data is included herein for a hip protection pad simulating a falling person, for a runner, and for a football helmet. Similar benefits are shown for baseball helmets, situations resulting in traumatic brain injury, and motorcycle helmets.

Many athletic activities involve repeated foot impacts with the ground surface. For example, during a 5 km run, body experiences approximately 3,000 impacts with the ground. Each impact produces a shockwave. The amplitude and duration of the shockwave depend upon several factors such as the running speed, the nature of the ground surface (soft vs. hard), the material and thickness of the sole of the running shoes, the anatomy of the foot, and above all, the running style of the runner, including whether running under shod or barefoot conditions.

FIG. 1 illustrates an exemplary shockwave profile. It is characterized in terms of gravity-directed acceleration (vertical force normalized by the body mass), and measured just below the right knee of a Rear Foot Strike (RFS) runner The profile shows two acceleration peaks, A₁ and A₂. The first peak is related to the kinematics of the knee as it moves towards the ground prior to the foot/ground impact. The second peak is related to the shockwave that is generated upon ground impact. When multiplied by the mass of the runner, it represents the peak dynamic force experienced by the knee upon each foot impact. This force lasts for a short duration, T₂, which typically ranges from 10 to 30 milliseconds for most runners. The rise-time (transient) and amplitude of the second peak is responsible for damaging the soft tissue structures of the knee capsule, notably the two menisci and the cartilage linings of the femur and tibia bones that articulate at the joint. The acceleration peaks of FIG. 1 are usually presented in units of acceleration due to gravity, g, which equals 9.8 m/s². This is also referred to as the G-force. Measurements have shown that shockwave amplitudes at the knees of recreational runners can reach 7 times the runner's bodyweight (or equivalently 7 g). Such high forces result because the downward momentum (or velocity) of the body is virtually brought to zero at ground impact. This is analogous to the situation where a fast-moving baseball when caught by a catcher produces a force on the catcher's hand that is several times the weight of the baseball.

Reducing the dynamic forces upon foot impact greatly benefits the soft tissue components of the knee and hip joints as it is their deterioration over time which eventually leads to arthritis. This beneficial effect can be quantified as follows.

The benefits of reducing the shockwave amplitude can be appreciated by relating it to the fatigue life of articular cartilage. How the force amplitude A affects the fatigue life of articular cartilage has been researched by Weightman who performed cyclic fatigue experiments in-vitro (tested outside the body) on cartilage specimens extracted from human cadavers of different ages. The extracted cartilages were loaded into a tension machine by straining the specimen from a zero stress (or Force) to a peak stress S (proportional to amplitude A, discussed here) and then the specimen was unloaded slowly to zero stress. This constituted one loading cycle. The machine was programmed to load the specimen with a large number of continuous cycles, each with an amplitude S. The number of loading cycles N that caused failure (fracture, damage, etc) of the cartilage was recorded. The data is represented by the following empirical equation: S=23−0.41 a−1.83 log₁₀N, where S is the failure stress measured in units of MN/m², a is the age of individual in years, and N is the number of cycles to failure, each with a maximum amplitude S. In the context of discussion here, the amplitude A of the shock wave is directly proportional to the stress S and each heel strike with the ground constitutes one cycle of loading. An average person makes approximately 10⁶ heel strikes per year on each foot. This is based on about 4.8 km (3 miles) of impact-running each day that could arise from simple running, stair climbing, or spot running during aerobic exercises in a gym. The value of S at the joints during normal walking has been estimated between 1.5 and 3 MN/m², which will correspond to A values of about 1.0 g. Magnitudes of both S and A increase during running, with the specific value depending upon the speed of the run. Since S and A are proportional, the factor by which S will increase will be roughly the same amount as the increase in the G-force (or A) measured in our experiments during running. This factor was found to be about 3 to 5 times. The increase in the cartilage life when the impact force level is reduced by 20% can then be estimated.

At running speed of 6.3 mph, S value is estimated to be about 7 MN/m². Based on equation (1), at this level of S, the cartilage life is about 38 years, 17.4 years, 3 years, and 0.9 year for population with 30 years, 40 years, 50 years and 60 years of age, respectively, assuming an individual makes 10⁶ foot-impacts each year. For a 30-year-old person, a 20% reduction in A (and hence in S) will result in an astonishing 5 times (500%) increase in the number of cycles to failure for a 30 yr old population. This will roughly correspond to 60 years of increased cartilage life. Similar calculations yield, on average, an enhancement of 17.4 years for 40 yr old, and 4.9 years for 50 yr old population. Similar calculations can be made at higher running speeds and different impact force levels.

In summary, the benefits of reducing impact forces, even in the small 10-20% range, can have a significant effect on fatigue life of articular cartilage. One way to do this is to use compliant insoles or midsole shoes, such as those provided in the modern footwear industry (Dr. Scholl's insoles). Unfortunately there is a limit as to how compliant the material can be made as the foot will sink more the more compliant the material is made (like running in sand). So what is needed is a material that supports the weight of the person but at the same time it reduces the impact by increasing the time T₂ in FIG. 1.

Moving on to head protection, the NFL has come under increasing public pressure to reduce the number of concussion-related injuries. FIG. 2 illustrates the probability of concussion risk as a function of the relative linear acceleration of two colliding helmets (based on reconstruction of hundreds of impacts from videos of NFL games, by Pellman et al.). The linear acceleration scale was also converted into a biomechanical injury parameter that essentially integrates the square of the acceleration-time curve. This parameter essentially captures the effect of peak acceleration and its duration during helmet-to-helmet contact, both of which are well known to control the onset of injury.

Fall related injuries in the growing geriatric population results in the fracture of the femur (hip bone) at the hip joint. Hip protector pads made from polyurethane foams placed inside a pouch are sold today which can be placed on the side of the undergarments. This reduces the dynamic force to below the fracture level of the femur. Since the collision time for this impact is also in the milliseconds range, use of polyurea was explored as a way to further make these commercially available hip protector pads more efficient.

Other protective pads suitable for the present system involving a layer of the present polyurea material include shin guards, knee pads, elbow pads, chest pads, leg pads, and any protective pad for use in a sport environment or otherwise environment where impact may occur.

FIG. 3A illustrates an exemplary polyurea material preparation process for use with the present system, according to one embodiment. Forming a layer of polyurea material included preparing a mixture 301 having a 4 to 1 ratio of soft phase to hard phase, wherein the soft phase comprises oligomeric diamine prepolymer and the hard phase comprises modified diphenylmethane diisoyanate and stirring the mixture for one minute 302. The hard and soft phases deform synergistically to give the material a viscoelastic property. A layer of the mixture is cast 303. The layer is cured at ambient conditions 304 for 24 hours, and the layer is cured for 24 hours in a vacuum 305 at 80° C. The layer is then adhered to a specimen 306 using a polyurea adhesive.

According to one embodiment, the layer of the mixture has a thickness in the range of 0.1 mm and 10 cm. The vacuum includes a pressure range of 2-3 millitorr.

It will be appreciated that, while the 4:1 ratio is described herein as a preferred ratio, the ratio can be changed from 2:1 to 8:1 (soft: hard phase) to give properties that are still superior to existing materials.

FIG. 3B illustrates an exemplary garment cross section including a layer of the present polyurea material, according to one embodiment. A garment for covering a section or the entire body 307 includes at least one layer of the present polyurea material 308 and optionally additional layer/material according to the specific garment 309. The garment reduces the impact force transmitted to the body through an object wearable on or against the body over the garment. The garment can be selected from the group consisting of a sock, glove, hat, hood, shirt, pant, sleeve, body suit, and the like.

FIGS. 4A-4D illustrate exemplary improved shoe designs including the present polyurea material, according to one embodiment.

FIG. 4A illustrates an improved shoe 400 having an upper 401 and an outsole 402. The shoe 400 includes an insole 404, a midsole 405, and an optional cushion 403. A thin layer of the present polyurea material 406 is situated below the insole 404 and above the midsole 405. It will be appreciated that the outsole 402, upper 401, insole 404, cushion 403, and midsole 405 can be made from any commercially available materials suitable for shoe construction. According to one embodiment, the layer of the present polyurea material 406 is between 0.1 mm and 10 cm in thickness.

FIG. 4B illustrates an improved shoe 420 having an upper 401 and an outsole 402. The shoe 420 includes a midsole 405, and an optional cushion 403. A thin layer of the present polyurea material 407 is situated as an insole above the midsole 405. It will be appreciated that the outsole 402, upper 401, cushion 403, and midsole 405 can be made from any commercially available materials suitable for shoe construction. According to one embodiment, the layer of the present polyurea material 407 is between 0.1 mm and 10 cm in thickness.

FIG. 4C illustrates an improved shoe 440 having an upper 401 and an outsole 402. The shoe 440 includes an insole 404, and an optional cushion 403. A thin layer of the present polyurea material 408 is situated as a midsole 408 below the insole 404. It will be appreciated that the outsole 402, upper 401, cushion 403, and insole 404 can be made from any commercially available materials suitable for shoe construction. According to one embodiment, the layer of the present polyurea material 408 is between 0.1 mm and 10 cm in thickness.

FIG. 4D illustrates an improved shoe 460 having an upper 401 and an outsole 402. The shoe 460 includes an insole 404 and a midsole 405. An insert 409 consisting of the present polyurea material is situated into a hole cut through the midsole 405. It will be appreciated that the outsole 402, upper 401, midsole 405, and insole 404 can be made from any commercially available materials suitable for shoe construction. In an alternate embodiment, the insert 409 is in the form of a plug preferably about 25 mm in diameter and about 8 mm thick and is inserted into a hole cut into the midsole.

It is understood that the exemplary shoe designs of FIGS. 4A-4D can be modified to include shoes wherein every component is made from the present polyurea material.

FIG. 5A illustrates a prior art helmet design. An exemplary prior art helmet includes at least an outer shell 501 and an inner layer of foam 502. Other prior art helmets include a shell, a stiff foam, and soft padding.

FIG. 5B illustrates an exemplary helmet design including the present polyurea material, according to one embodiment. An exemplary improved helmet includes an outer shell 501 and an inner layer of form 502. A layer of the present polyurea material 503 is positioned inside of the inner foam 502 such that it is closest to the head to be protected. According to one embodiment, the layer of the present polyurea material 503 is 0.5 mm to 1.0 mm in thickness. According to one embodiment, the layer of the present polyurea material is between 0.1 mm and 10 cm in thickness

FIG. 5C illustrates an exemplary helmet design including the present polyurea material, according to one embodiment. An exemplary improved helmet includes an outer shell 501 and an inner later of form 502. A layer of the present polyurea material 504 is positioned between the outer shell 501 and the inner foam 502. According to one embodiment, the layer of the present polyurea material 504 is 0.5 mm to 1.0 mm in thickness. According to one embodiment, the layer of the present polyurea material is between 0.1 mm and 10 cm in thickness.

FIG. 5D illustrates an exemplary combat helmet cross section including the present polyurea material, according to one embodiment. According to one embodiment, an improved combat helmet involves a layer of the present polyurea material. The improved combat helmet is for managing hypervelocity impacts, which are generated by weapons in modern warfare, such as shaped charges and explosively formed projectiles which can attain speeds between 9,000 ft/s to 30,000 ft/s. An improved combat helmet cross section includes a layer of the present polyurea material 506 sandwiched between steel, aluminum, glass, acrylic, or polycarbonate plates 505, 506.

In an alternate embodiment, a layer of the present polyurea material can be included in armor for vehicles, aircraft, and other structures exposed to impacts in the microseconds to milliseconds durations. A layer of the present polyurea material can be included in a wall of a building, a wall or door of an aircraft, on the exterior of an aircraft, on a bumper of a vehicle, on a tank, on a hum-vee, or anywhere on a ship.

FIG. 6A illustrates an exemplary improved hip pad including the present polyurea material, according to one embodiment. An exemplary improved hip pad includes an adhered side 601 which is adhered to an impacted area, and foam pad 603. A thin layer of the present polyurea material 602 is positioned between the adhered side 601 and the foam pad 603. The foam pad 603 is positioned inside a nylon pouch 605 that includes an air pocket 604. According to one embodiment, the layer of the present polyurea material 602 is 0.5 mm to 1.0 mm in thickness. FIG. 6B illustrates an exemplary improved protective pad including the present polyurea material, according to one embodiment. An exemplary improved protective pad includes a protective pad 608 and a layer of the present polyurea material 607 positioned between the area of the body to be protected 606 and the protective pad 608. According to one embodiment, the layer of the present polyurea material 607 is 0.5 mm to 1.0 mm in thickness.

Four specific applications were explored using the same material polyurea recipe, discussed above. Within each application, the performance of the new polyurea impact manager is compared with the currently available solutions. Details of these tests are given below. A very thin layer of polyurea is effective in managing these impacts because it exhibits a rare combination of mechanical properties, a very high bulk modulus and a very low shear modulus (as previously mentioned). The high bulk modulus allows retention of high through-thickness stiffness such as against the foot pressure applied by a runner while the low shear modulus results in long relaxation times which in turn brings down the peak dynamic impact force. For most materials available prior to the present polyurea material, the bulk modulus and shear modulus are positively correlated. That is, the higher the bulk modulus, the higher is the shear modulus. This is the technological reason why polyurea is quite effective in attenuating dynamic forces comparable to existing materials, but with significantly less thickness.

An unmodified sneaker was used as a control. The modified sneaker included a layer of 0.5 mm thick polyurea insole glued to the inside of the shoe after removing the thin insole that came with the shoe. The original insole was then replaced on top of the polyurea insole (refer to the configuration illustrated in FIG. 4A). An additional control was also prepared in which the polyurea insole was replaced by a 5 mm thick conventional insole which was marketed as an insole for running and not walking. Compared to the polyurea insole, it was 10 times thicker, and was composed of a complicated three-layer system: very soft gel, cloth cover and a hard plastic bottom. Runners also ran barefoot.

Since impact shock is known to vary systematically with running speed and surface gradient, changing the speed and gradient of a motorized treadmill provided a convenient means for manipulating the levels of impact shock in the laboratory environment. The use of a treadmill allowed maintaining a proper control over walking and running speeds across different runners. Axial acceleration of the lower right leg was recorded by means of a piezo-resistive accelerometer attached to the skin overlying the tibia with the sensitive axis of the accelerometer aligned with the long axis of the bone. This site was selected because the soft tissue overlying the bone is relatively thin at this point. The output was collected and recorded by a digital oscilloscope. Speeds used in testing were 2.9 mph, 6.3 mph, 7.4 mph, and 9.2 mph. Both the unmodified sneaker (control) and barefoot samples were taken for reference. A 75 kg male heel-strike runner was used as the test subject.

FIG. 7A illustrates tibial acceleration at different speeds, ranging from walking (2.9 mph) to running (9.2 mph). While the control (unmodified sneaker) shows a decrease in acceleration compared to barefoot, the addition of polyurea layer just below the insole shows better performance across the spectrum. A conventional running insole is also used for comparison, which is constructed out of three different materials specifically very soft gel, cloth cover and hard plastic bottom. The present system includes one layer of polyurea which exhibits high bulk modulus and provides high axial stiffness against the applied foot pressure (so the runner's foot does not sink in) and relatively low shear modulus which allows longer relaxation times which in turn brings down the peak dynamic impact force. A runner using a conventional insert will undergo a significantly more downward deflection compared to polyurea insert. Thus the polyurea insert is ideal for high performance basketball shoes where the less deflection in the thickness direction is needed so that it does not slow down the players during his turning, twisting and jumping maneuvers. At the fundamental micro structural level, polyurea is composed of a hard segment and a soft segment and this effectively does the work of three separate and thick layers of prior work.

Additional tests with thicker polyurea (1 mm) have shown the same performance as a conventional running insole albeit still at one-fifth the thickness.

FIG. 7B illustrates impact force reduction resulting from adding the present polyurea material to a shoe, according to one embodiment. In a separate experiment, placement of a 1.92 mm thick insole formed of the present polyurea material inside a non-branded shoe, just below its existing thin insole, resulted in an impact force reduction of 18%. The best performance was obtained when a plug of new material 25 mm in diameter and 8 mm thickness was placed in a cavity created in the heel section of the shoe. The impact force was reduced by 31% compared with the control.

The polyurea material was applied to the best performing helmet from a recent NFL-sponsored study. Based on this study, a drop weight standard was developed, which involved dropping an inverted helmet draped over a head form onto an anvil with an equivalent energy of 74 Joules. A comparable test was performed herein where the helmet was kept stationary and the load was dropped on top of it with an energy equal to 74 J. The best performing helmet from a study that was recently conducted by NFL was used for a control. The force that was transmitted through the helmet was measured using a piezoelectric load cell (Kistler Model 9201A). A cylindrical impact head was used to mimic the curvature of a helmet that would impact the tested helmet and cause injury in a sport. The load cell was preloaded as per the specifications of the manufacturer prior to each impact. Polyurea layers of different thickness were tested. The location of the polyurea layer on the helmet was also examined

FIGS. 8A-8E illustrate exemplary test configurations for application of the present polyurea material to helmets. FIG. 9 illustrates the peak force for various polyurea thicknesses and locations in a helmet impacted with 74 Joules of impact energy, according to the configurations in FIGS. 8A-8E.

A 0.5 mm thick layer of polyurea 806 adhered to the inside of the helmet (FIG. 8D) provided a significant reduction in the transmitted force. Adhering the polyurea layer (804, 805) to the outside of the helmet provided detrimental results (FIGS. 8B, 8C). This is because the outer polyurea layer makes the helmet shell quite stiff and increases the dynamic force by reducing the collision time. The polyurea material plus a helmet structure in which the polyurea layer of a given thickness is placed on the inner-surface (either on the inside surface of the hard shell or on the outer surface of the inside foam which contacts the athlete's head), is a preferred implementation (FIGS. 8D, 8E, 5C).

FIG. 10 displays the impact force reductions resulting from adding the present polyurea material to a helmet, according to one embodiment. Use of a 0.5 mm thick liner inside the Riddell Revolution helmet (presently used by NFL players) reduced the impact forces between 20% and 36%, depending upon the impact energy.

FIG. 11 illustrates a revised concussion probability curve as a result of the modified helmet according to FIG. 10. The risk of concussion fell from 43% to 28%, representing a significant improvement.

FIG. 12 illustrates impact data using a baseball helmet having the present polyurea material, according to one embodiment. The impact data was obtained at energy levels that are typical of mimicking an impact from a 90 mph fast baseball striking the helmet. The data shows an improvement of 33% by use of the polyurea layer.

Since the collision duration for riders impacting the pavement from a bicycle or a motorcycle in an accident are very similar to those in the helmet-to-helmet impact on a football field, the exact same strategy works for protecting the riders by designing polyurea-based helmets. The energy during impact is however much higher.

Another helmet application for polyurea layers described herein is for protecting soldiers from the traumatic brain injury (TBI). The latter is a long-term effect caused by the trauma to the brain tissue, which in turn is caused by the shockwaves generated by the explosions.

FIG. 13 illustrates a pressure-time curve from military blasts measured in the 1 to 10 milliseconds range. Impacts on polyurea-modified helmets have been carried out herein with impact energies that mimic the intensity typically experienced by a soldier who would be diagnosed with TBI.

The effectiveness of the present polyurea material was also investigated in managing hypervelocity impacts, which are generated by weapons in modern warfare, such as shaped charges and explosively formed projectiles which can attain speeds between 9,000 ft/s to 30,000 ft/s. Threats from these deadly hypervelocity penetrators pose significant challenge to the armor design community as no data is available with respect to conventional armor materials at these extreme high loading rates. In contrast to the above applications where collision times ranged from 1 millisecond to tens of milliseconds, hypervelocity impacts are characterized by collision times in 1 to tens of nanoseconds (million times faster than those discussed above), even microseconds. Layered armors were fabricated herein where polyurea layers are placed sandwiched between steel, aluminum, glass, acrylic, and polycarbonate plates to see if these combinations of materials result in defeating such impacts.

FIGS. 14 and 15 illustrate the impact results of layered armors having layers of the present polyurea material, according to one embodiment. The input wave that is generated on the left side and made to propagate towards the right is completely dissipated by the time it comes out from the right hand side. Such nanoseconds impacts were generated in a laser-generated shock wave facility. The results are quite remarkable in not only that it dramatically cuts down the input (from the left) wave but the exact same material seems to work in managing impact in the 1-100 milliseconds collision time-frame. Peak shockwave amplitudes were cut down by over 90%.

As a result, advanced helmets and advanced multilayer armors involving the present polyurea material and metal layers can be made for protecting ground vehicles and aircrafts (e.g. helicopters, drones, spaceships).

To test protective pad embodiments, samples were prepared by placing thin polyurea layers on top of commercially available hip protector pads.

FIG. 16 illustrates an improved impact pad test configuration. The surrogate hip model used to test the pads consisted of a composite large left femur (Sawbones Model 3406, Vashon, Wash.) approximately 48.5 cm long, fixed to a pivot point attached to an aluminum base at the distal end, through the femoral condyles. The angle between the long axis of the bone and the plane perpendicular to the axis of impact was held constant at 17.5 degrees. A piece of neoprene rubber with a stiffness of 100 kN/m was used to simulate the hip joint stiffness. The effective mass of the surrogate pelvis was 11.7 kg. Pelvic compliance was simulated using four steel springs, each with a spring constant of 18.75 kN/m (Atlantic Spring Company, Flemington, N.J.) for a total effective stiffness of 75 kN/m. A piezoelectric load cell was mounted between the femoral head and pelvic mass.

Soft tissue covering the hip was simulated using Plastazote (Atlas International Model PL-34W, Rancho Cordova, Calif.), a polyethylene foam. A vertical loading drop weight machine (Instron 8250 DynaTup, Canton, Mass.) was used to impact the mechanical hip. The total energy at impact was 80 joules. A stainless steel impact platen was attached to the crosshead tup. The impact surface area was 0.0045 m². The entire drop weight mass was guided by two vertical rails, which insured the impact area was the same for each repeated impact.

Impact force data was measured with the aforementioned piezoelectric load cell (Kistler Instruments Model 9021A, Amherst, N.Y.) affixed to the pelvic mass, recording the impact load proximal to the femoral head. After calibration of the test setup was complete, the configuration was not altered during the course of experimentation. All values for force refer to force transmitted through the bone and recorded by this load cell. The impact test was also repeated without the surrogate hip model.

FIG. 17 illustrates the force-time curves for a hip impact pad with and without a layer of the present polyurea material. Impacting the polyurea layer significantly reduces the transmitted force to the hip joint during a fall. The layer of polyurea, when adhered to the side that is impacted, produces the most valuable results in reducing the force. The data shows that the impact can be reduced by 11%. Other data obtained from a setup in which the hip bone was not used showed even a higher benefit of 52%. The characteristic time of these impacts is also between 1 ms and 100 ms.

Unlike conventional impact absorbing or resistant materials in which dynamic energy absorbing properties are only effective when the materials are stretched 50 to 100 times more than what would actually occur in a typical sports or recreational related impact applications, the present polyurea material provided significant reduction of such impact forces. When thin layers of the polyurea material were tested using impact tests that mimicked collision durations typical in contact sports, the impact forces were significantly reduced even with small deformations. The reason for this is that the material relaxes in shear (in the plane of the sheet) because of its low shear modulus and this allows the impulse time to increase long enough to reduce the peak dynamic forces via the Newton's second law. This unexpected behavior has not previously been discussed by others.

In the description above, for purposes of explanation only, specific nomenclature is set forth to provide a thorough understanding of the present disclosure. However, it will be apparent to one skilled in the art that these specific details are not required to practice the teachings of the present disclosure.

The various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter.

Material for mitigating impact forces with collision durations in nanoseconds to milliseconds range has been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

What is claimed is:

1. An object wearable on or against a human body for mitigating impact forces, the object comprising
a wearable structure, and
a layer of polyurea material positioned within or attached to the wearable structure, the layer of polyurea material comprising a combination of hard and soft phase material, wherein the ratio of soft phase to hard phase is in a range of about 2-to-1 to about 8-to-1.

2. The object of claim 1 wherein ratio of soft phase to hard phase is about 4-to-1.

3. The object of claim 2 wherein the soft phase comprises polyamine prepolymer and the hard phase comprises polyisocyanate.

4. The object of claim 3 wherein the soft phase polyamine prepolymer comprises oligomeric diamine prepolymer and the hard phase polyisocyanate comprises modified diphenylmethane diisocyanate.

5. The object of claim 1 wherein the layer of material is positioned between the human body and an outer structure of the wearable structure.

6. The object of claim 1 wherein the wearable structure comprises one of a helmet, a hat, a cap, a hood, and a protective pad.

7. The object of claim 1 wherein the wearable structure comprises body fitting liner for a head.

8. The object of claim 1 wherein thickness of the layer of material is in a range between 0.1 mm and 10 cm.

9. The object of claim 2 wherein thickness of the layer of material is in a range between 0.1 mm and 10 cm.

10. The object of claim 1, wherein the wearable structure comprises a protective pad comprising
a body having an impact side, and
a pad, wherein the pad is between the impact side and the layer of material.

11. The object of claim 10, wherein the protective pad is formed into one of a body fitting liner for a head, a helmet, a hat, a hood and a cap.

12. A helmet for mitigating impact forces, comprising:
an outer shell; and
a layer of polyurea material comprising a combination of hard and soft phase material, wherein the ratio of soft phase to hard phase is in a range of about 2-to-1 to about 8-to-1.

13. The helmet of claim 12 wherein ratio of soft phase to hard phase is about 4-to-1.

14. The helmet of claim 12 wherein the soft phase comprises polyamine prepolymer and the hard phase comprises polyisocyanate.

15. The helmet of claim 14 wherein the soft phase polyamine prepolymer comprises oligomeric diamine prepolymer and the hard phase polyisocyanate comprises modified diphenylmethane diisocyanate.

16. The helmet of claim 15 wherein the layer of polyurea material is positioned between the human head and the outer shell of the helmet.

17. The helmet of claim 15 wherein thickness of the layer of polyurea material is in a range between 0.1 mm and 10 cm.

18. The helmet of claim 15 further comprising an inner foam section, wherein the layer of material is positioned below the outer shell of the helmet.

19. The helmet of claim 12 wherein the layer of polyurea material is in the form of a foam.

20. The object of claim 1 wherein the layer of polyurea material is in the form of a foam.

21. A method for forming a layer of polyurea material for mitigating impact forces comprising the steps of:
mixing hard and soft phase materials at a ratio in the range of 2 to 1 to 8 to 1 of soft phase material to hard phase material, wherein the soft phase material is a polyamine prepolymer and the hard phase material is a polyisocyanate,
casting a layer of the mixture, and
curing the layer of the mixture at ambient conditions or under vacuum conditions.

22. The method of claim 21 wherein the soft phase polyamine prepolymer comprises oligomeric diamine prepolymer and the hard phase polyisocyanate comprises modified diphenylmethane diisocyanate.

23. The method of claim 21 wherein the step of mixing hard and soft phase materials includes mixing hard and soft phase materials at a ratio of 4 to 1 of soft phase material to hard phase material.
